(19) United States
(12) Patent Application Publication
(10) Pub. No.: US 2008/0303957 A1
(43) Pub. Date: Dec. 11, 2008

(54) Modular Entertainment and Data System

(76) Inventors: Steven Soper, Glendale, AZ (US); Eric Olson, Cave Creek, AZ (US); Julie J. Chen, Seattle, WA (US); Darryl S. Komesu, Scottsdale, AZ (US); Salar Navidi, Glendale, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/482,016

(22) PCT Filed: Oct. 17, 2001
(86) PCT No.: PCT/US01/32398

§ 371 Date: Mar. 25, 2008

Related U.S. Application Data
(60) Provisional application No. 60/241,389, filed on Oct. 18, 2000.

(51) Int. Cl. H04N 5/44; H04N 5/64

(52) U.S. Cl. 348/725; 348/837; 348/E05.096; 348/E05.128

(57) ABSTRACT

A modular, reconfigurable entertainment and data system provides data to at least one user. A cabinet is provided which contains a plurality of module receiving rails therein. A power supply module is positioned on a first one of the rails and provides an operating potential. An entertainment/data module is positioned on a second rail and a control module is positioned on a third one of the module receiving rails and provides an interface between the user and the entertainment/data module.

### CROSS REFERENCE TO RELATED APPLICATIONS

This is a non-provisional application based on U.S. Provisional Patent Application having Ser. No. 60/241,389 entitled “MULTIPLE RECEIVER UNIT” filed Oct. 18, 2000.

### TECHNICAL FIELD

This invention relates generally to entertainment and data systems, and more particularly to a multi-regional, modular, reconfigurable entertainment system capable of receiving TV and data in a plurality of formats.

### BACKGROUND OF THE INVENTION

Aircraft control systems are among the most complex control systems manufactured. The functions controlled by these systems range from relatively simple and non-critical functions such as cabin lighting and temperature control to complex functions such as flight control and flight management. While they perform different functions, all aircraft control systems are continually scrutinized for ways to reduce system weight, size, and cost.

Most aircraft control functions are implemented in a dedicated box or line replaceable unit (LRU), which contain the necessary processing and input/output (I/O) electronics to perform the required function. Such is the case with aircraft onboard entertainment systems.

Such airborne entertainment systems commonly include a video play and viewing system wherein a selected movie on videotape is played under the control of a crew member and viewed by passengers on a number of viewing screens deployed at various locations throughout the aircraft's passenger compartment. Not only does this system require crewmember intervention, but also the passengers typically have no viewing control or choice of movie selection or access to other forms of entertainment.

To overcome certain ones of these disadvantages, entertainment systems including live TV, games, etc., have been developed and deployed on aircraft. Such systems have generally been housed in multiple boxes or LRU's; i.e., one LRU may contain the system power supply, another the antenna control unit, and still another the receiver, and so on. These separate LRU's are then mounted at various locations throughout the aircraft. To further complicate the situation, aircraft engaging in international flights may encounter multiple regions providing TV service from a number of different satellite TV providers; e.g., DirecTV in the USA, Expressvu in Canada, and TPS (La Television Par Satellite) in France. In fact, an international carrier may require as many as twelve different receivers all of which are housed in the same box or LRU. This presents several disadvantages.

On a given route or flight, perhaps only a few different receivers would be necessary; however, since all the receivers are housed in a single box, all the receivers must be carried on the flight thus occupying additional space and contributing extra weight. If it became necessary to add a new receiver, either because a new service had become available or because travel to new regions has become necessary, the existing receiver box would have to be removed from the main chassis and replaced by an entirely new receiver box. This would have to be accomplished, in all likelihood, at an aircraft modification center as would other forms of upgrades and enhancements.

In view of the foregoing, it should be appreciated that it would be desirable to provide a light-weight and compact multi-regional entertainment and data system capable of receiving TV signals from a number of satellite TV providers in different formats and including DVD, games, and data and other capabilities. Such a system would better meet the constraints of an airborne environment. Additional desirable features will become apparent to one skilled in the art from the foregoing background of the invention and the following detailed description of a preferred exemplary embodiment and appended claims.

### SUMMARY OF THE INVENTION

In accordance with the teachings of the present invention, there is provided a modular, reconfigurable entertainment system for supplying data to at least one user. A cabinet is provided which contains a plurality of module receiving rails therein. A power supply module is positioned on a first one of the rails and provides an operating potential. An entertainment module is positioned on a second rail, and a control module is positioned on a third one of the module receiving rails to provide an interface between the user and the entertainment module.

### BRIEF DESCRIPTION OF THE DRAWINGS

The present invention will hereinafter be described in conjunction with the appended drawings wherein like numerals denote like elements in which:

FIG. 1 is a graphical representation of an aircraft equipped with the inventive modular multi-regional entertainment and data system;

FIG. 2 is an isometric view of a subsystem including a plurality of replaceable modules contained within a cabinet in accordance with the teachings of the present invention;

FIG. 3 is an isometric view of the cabinet shown in FIG. 2 for housing a plurality of modules;

FIG. 4 is a functional block diagram of a modular multi-regional entertainment and data system in accordance with the teachings of the present invention;

FIG. 5 is an exploded view of an exemplary module of the type shown in FIG. 2;

FIG. 6 is a back view of a module of the type shown in FIG. 2;

FIG. 7 illustrates a keying arrangement, which may be implemented on the back of each of the modules shown in FIG. 2 to ensure that each of the modules is properly positioned in the correct slot;

FIG. 8 is a block diagram of a DVD module for use in the inventive modular entertainment system;

FIG. 9 is a block diagram including a game module for use in the inventive modular entertainment system;

FIG. 10 is a block diagram including a data module for use in the inventive modular entertainment system; and

FIG. 11 and FIG. 12 are block diagrams of an audio/video recorder module for use in the inventive modular entertainment system.

### DESCRIPTION OF THE PREFERRED EXEMPLARY EMBODIMENT

The following detailed description of a preferred embodiment of the invention is exemplary in nature and is not intended to limit the invention or the application or use thereof. For example, while the invention is described as being deployed in an airborne environment, it is equally suitable for use in connection with other transportation means; e.g., train, boat, etc.

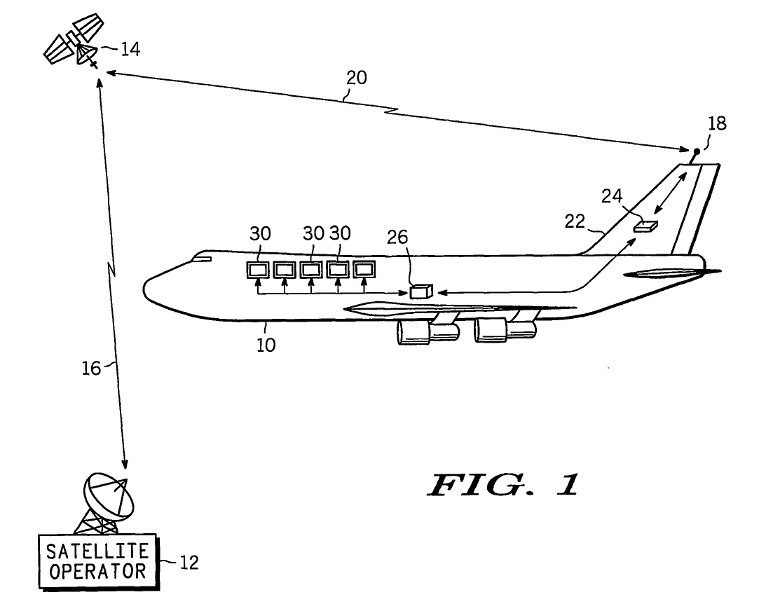

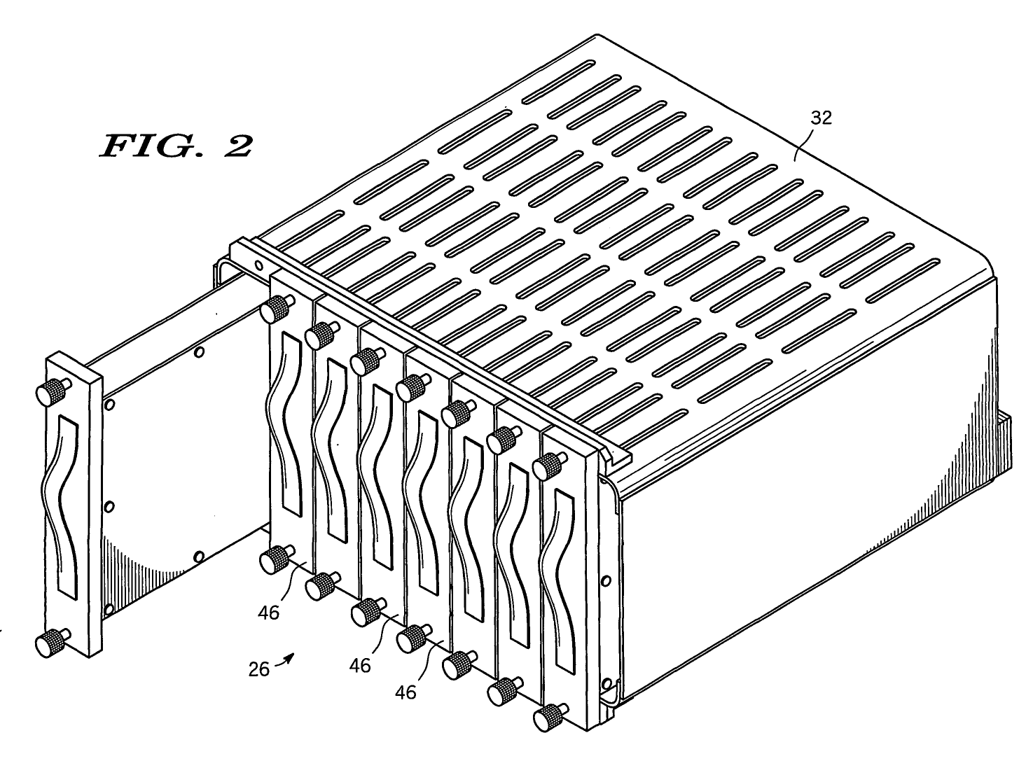

Referring to FIG. 1, there is shown an aircraft 10 that is equipped with an inventive, multi-regional, modular, entertainment and data system. The system is capable of receiving data and capable of receiving TV from a satellite operator 12 via satellite 14. As can be seen, the signal is transmitted from satellite operator 12 and received at satellite 14 via link 16. The TV is then transmitted to antenna 18 via link 20. Antenna 18 can be mounted on either the aircraft fuselage or on the vertical stabilizer 22 of aircraft 10. Antenna 18 then relays data in a first frequency band (e.g., the Ku frequency band) to a down-converter 24. Down-converter 24 converts the data to a second frequency band (e.g., the L-band frequency range) and applies it to a modular, reconfigurable, entertainment subsystem 26 containing a plurality of modules 46 (FIG. 2). Entertainment subsystem 26 processes the TV and provides it to a plurality of user display and connection stations 30 for use and viewing by the ultimate user, and also provides antenna control data back to down-converter 24 and antenna 18 to assure that it is properly positioned to receive data from satellite 14.

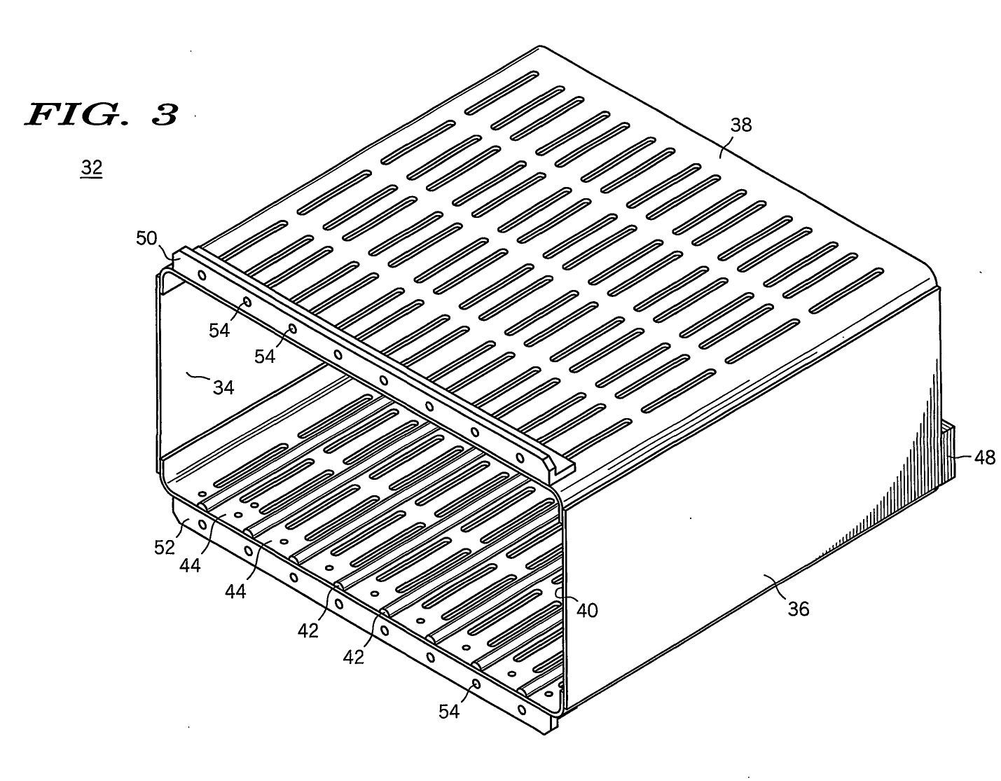

Referring now to FIG. 2 and FIG. 3, entertainment and data subsystem 26 includes a cabinet 32, which comprises sidewalls 34 and 36 and top and bottom 38 and 40 respectively, preferably vented as shown. Bottom 40 and top 38 are provided with a plurality of guides or rails 42 so as to define a plurality of slots 44 therebetween. Modules 46 are positioned within cabinet 32 by simply sliding them onto an appropriate rail 42 until they engage backplane 48 (FIG. 3) and other connectors (not shown), which as is well known, provides a common communication connection to elements and modules within the entertainment and data subsystem 26. For example, the PCI bus in a personal computer acts as a backplane. Through the use of a backplane, the majority of communications between modules 46 are locally constrained within the cabinet housing of the entertainment and data subsystem.

The open end of cabinet 32 is provided with upper and lower flanges 50 and 52, which are rigidly coupled to front portions of top member 38 and bottom member 40 respectively. Each contains a plurality of internally threaded openings 54 therein, to which modules 46 may be secured as will be described further hereinbelow. While FIG. 2 shows eight modules 46 positioned within cabinet 32, it should be clear that cabinet 32 might be designed to accommodate any number of modules which are necessary to carry out a desired function.

FIG. 4 is a block diagram of the inventive modular multi-regional entertainment and data system. Entertainment and data subsystem 26 includes cabinet 32, which is provided with a plurality of module receiving rails 42 and a backplane 48 as described above. Positioned on rails 42 are a plurality of modules; i.e., a multi-switch control module 56, an antenna control module 58, a power supply module 60, TV receiver modules 62 and 64, DVD module 66, game module 65, data module 67, and audio/video recorder module 69 respectively. TV receiver module 62 may be designed to receive, for example, DirecTV in the USA, and receiver module 64 may be designed to receive Expressvu in Canada. While only two TV receiver modules are shown in FIG. 4, it should be clear that additional rails could be provided to include other receiver modules designed to receive other TV formats. Furthermore, additional receiver modules could be provided and the system reconfigured to include Internet data, email, graphical weather data, TV replay, etc. Thus, it should be clear that the wiring of the cabinet which houses the entertainment subsystem can be configured to accommodate many different entertainment capabilities.

As stated previously, antenna 18 receives TV data from satellite 14 and provides TV data (e.g., Ku band) to down-converter 24, which in turn provides L-band data to multi-switch control module 56. The aircraft navigation system 68 is coupled to antenna control module 58 and provides information relating to the heading of the aircraft. From the navigation data, antenna control module 58 determines the direction that antenna 18 should be pointed in order to obtain an adequate satellite TV signal. This data is provided to antenna 18 in order to properly position it. Navigation system 68 (e.g. a super attitude heading system (AHRS) or an inertial reference system (IRS)) is isolated (preferably optically) from entertainment and data subsystem 26 as is shown at 70 so as to protect the navigation system bus from any malfunctions that might occur in the entertainment and data system since this bus is involved in critical aircraft and cockpit functions.

Entertainment and data subsystem 26 includes a power supply module 60 for providing a source of potential to antenna 18, down-converter 24, and to the remainder of subsystem 26. The wiring of the aircraft cabinet into which entertainment and data subsystem 26 is positioned may be designed to accommodate different power supply modules. The system utilizes 28 volts DC if deployed, in a corporate aircraft or 115 volts AC if deployed in a commercial airliner.

Finally, in-flight entertainment equipment 72; i.e., the plurality of user display and connection stations 30 shown in FIG. 1, are coupled to receive and display data from receiver modules 62 and 64, DVD module 66, game module 65, and data module 67, respectively. This equipment is also coupled to multi-switch control module 56 for reasons that will be discussed below.

To illustrate the operation of the inventive modular multi-regional entertainment and data system, assume that an aircraft is flying over the United States and that receiver 62 is designed to receive television information in a first format corresponding to, for example, DirecTV. Receiver module 62 receives this information from antenna 18 via down-converter 24 and multi-switch control module 56, processes the data, and provides it to user display and connection stations 30. Multi-switch control module 56 receives position data from inertial reference system 68, which is indicative of aircraft location and compares this data with a map of the regional TV satellite systems to determine what satellites are available in a region and what regional system should be used. When it is determined that the aircraft has crossed for example, the Canadian/USA border, multi-switch control module 56 can automatically disconnect receiver module 62 from the system and insert in its place receiver module 64 which is designed to receive Canadian Expressvu. Alternatively, each user of the display station may be provided with a control mechanism for switching from receiver module 62 to receiver module 64 upon receipt of a text message from multi-switch control module 56 which appears on the user's display and informs the user that the aircraft has left the United States and entered Canadian airspace. The text message will also specify which receiver to select. Multi-switch control module 56 may also provide other forms of status messages to a user of a display station and respond to certain user commands. Of course, receiver modules could be provided for France, Latin America, the Middle East, etc.

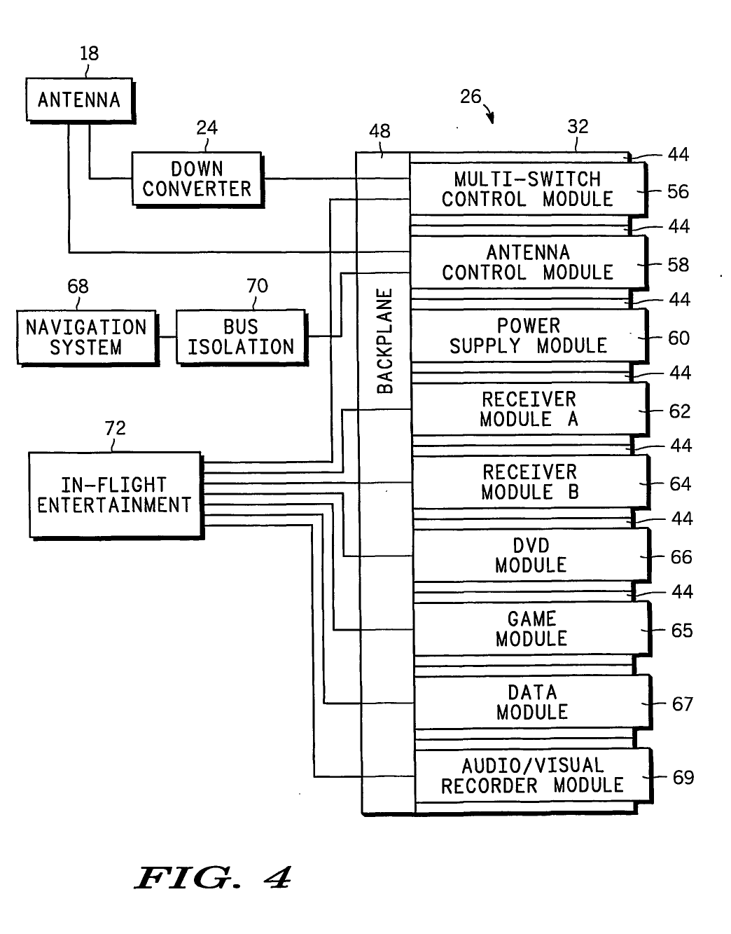

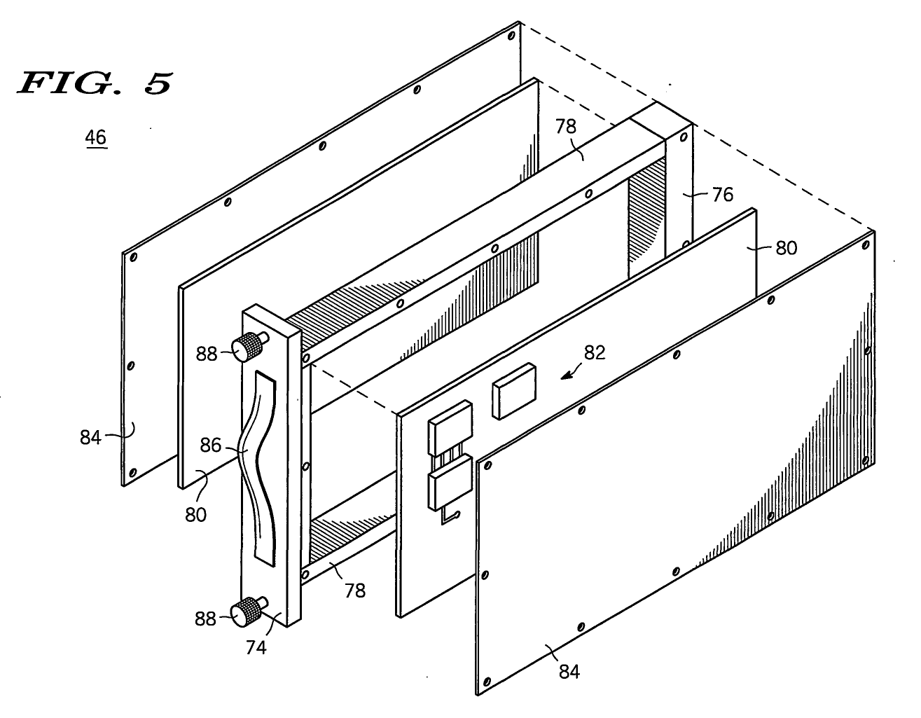

FIG. 5 is an exploded view of one of the modules 46 shown in FIG. 2. A front or face portion 74 is coupled to rear connecters 76 via connecting portions 78 forming a generally rectangular frame adapted to receive first and second printed circuit boards 80. Circuitry 82 on printed circuit boards 80 is configured to perform a required function and communicates with other modules and components of the system via connecters 76 and backplane 48 (not shown). Printed circuit boards 80 are fastened to one or more of members 74, 76, or 78. Metal covering plates 84 are likewise fastened to one or more of members 74, 76, 78 and protect printed circuit boards 80. Front plate 74 is provided with a handle 86 and thumbscrews 88 having externally threaded portions (not shown) that engage internally threaded apertures 54 shown in FIG. 3. Thus to insert a module 46, one need only slide the module into one of rails 42 (FIG. 3) until rear connector portion 76 engages backplane 48 (FIG. 4). The module may then be secured in the cabinet by threading thumbscrews 88 into apertures 54 (FIG. 3).

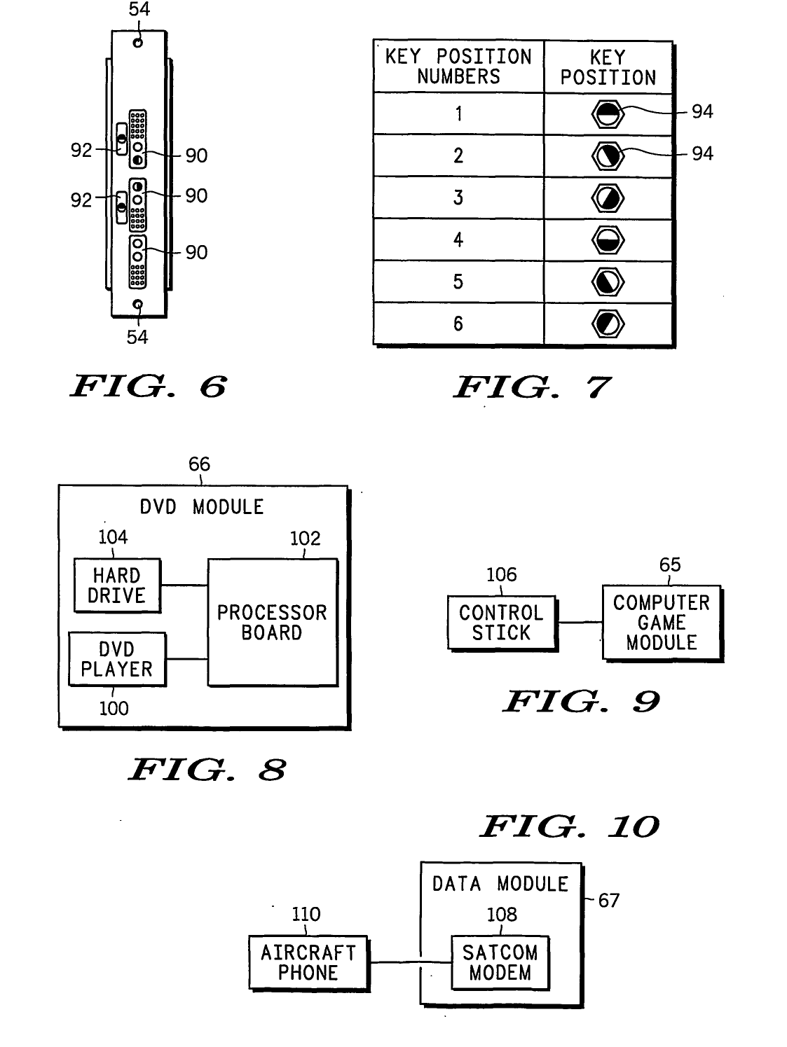

FIG. 6 is a rear view of connecting portion 76 (FIG. 5), which engages backplane 48 (FIG. 4). As can be seen, it contains a plurality of connectors 90 which accomplish the electrical coupling between the individual module and backplane 48. To prevent a module from inadvertently be inserted on an incorrect rail, each module is provided with a key 92 which engages a corresponding receptacle in backplane 48. FIG. 7 illustrates several possible key positions where the darkened portion 94 represents a protrusion that is received in a correspondingly shaped aperture.

FIG. 8 is a block diagram of DVD module 66. As can be seen, it includes DVD player 100 and processor board 102. Optionally, a hard drive 104 may be provided such that the music or movie on specific CD's may be stored in hard drive 104 thus eliminating the need to carry and store CD's onboard the aircraft.

Referring to FIG. 9, computer game module 65 is shown being utilized with, for example, a control stick 106 which would be located at the user display and connection station 30.

FIG. 10 is a block diagram of data module 67 which may include a Satcom modem 108. Aircraft phone 110 may receive or transmit via modem 108 and a wireless ground link. Additionally, the handset, which is part of a satellite phone system, may be utilized in conjunction with data module 67.

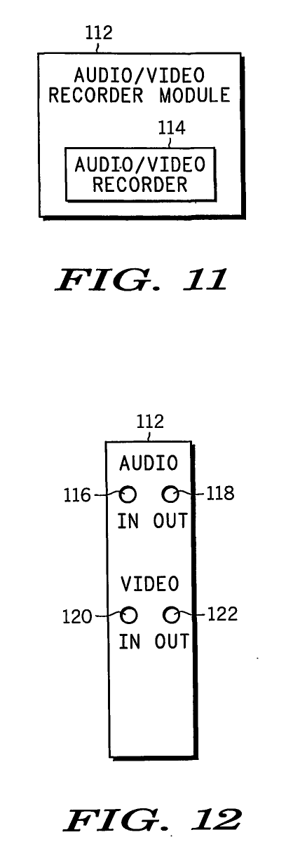

FIG. 11 and FIG. 12 illustrate an audio/video recorder module 112 for use in the inventive modular entertainment system. Audio/video recorder module 112 contains an audio/video recorder 114; e.g. a camcorder, compact disk burner, etc., and may also include audio input and output terminals 116 and 118 respectively and video input and output terminals 120 and 122 respectively. Input terminals 116 and 120 could be coupled to a receiver such as a microphone or a lens located on the module front panel or remotely located in the cockpit, cabin, storage area or any other location. Output terminals 118 and 122 could be coupled to displays 30 within the cockpit or cabin, or broadcast via satellite or other broadcast/receiver operator. Module 112 could include a continuous loop recording medium capable of recording from several minutes to several hours of audio and/or video depending on user requirements.

Thus, there has been provided a modular reconfigurable entertainment and data system for use in a size/weight sensitive environment (e.g. on an aircraft). The system may be a multi-regional TV system that permits users to view live TV in multiple formats corresponding to different geographic regions. The system is flexible in design and easy to upgrade. Due to it's modular design it is light, compact, and does not require the use of multiple LRU's. Its modular nature requires that only those receivers that are needed on a given flight be taken and the rest may be left behind. All the modules plug into a single cabinet and are therefore all located in one place. Troubleshooting may be accomplished by a crewmember simply replacing modules. Such replacement would require only a sign-off by the crewmember as a minor maintenance activity. Should a new TV format become available, it would only be necessary to obtain a new module. Due to its modular design, the inventive multi-regional entertainment and data system reduces configuration management, is easily reconfigurable in route, and enables quick modification of the system. Not only does this result in reduced overall cost to the customer, but also obsolescence may be addressed without impacting current customer performance.

While the invention has been described in the foregoing detailed description of a preferred exemplary embodiment, it should be appreciated that a vast number of variations in the embodiments exist. It should also be appreciated that this preferred exemplary embodiment is only an example, and is not intended to limit the scope, applicability, or configuration of the invention in any way. Rather, the foregoing detailed description provides those skilled in the art with a convenient road map for implementing a preferred exemplary embodiment of the invention. Changes in form and detail may be made by one skilled in the art without departing from the spirit and scope of the invention as set forth in the appended claims.

What is claimed is:

1. A modular, reconfigurable, entertainment and data system for supplying data to at least one user, comprising:
a cabinet having a plurality of module receiving rails therein.
a power supply module for positioning on a first one of said plurality of module receiving rails for providing and operating potential;
an entertainment module for positioning on a second one of said plurality of module receiving rails; and
a control module for positioning on a third one of said plurality of module receiving rails and providing an interface between said at least one user and said entertainment module.

2. A modular, reconfigurable entertainment and data system according to claim 1 wherein said entertainment module is a DVD module.

3. A modular, reconfigurable entertainment and data system according to claim 1 wherein said entertainment module is a game module.

4. A modular, reconfigurable entertainment and data system according to claim 1 wherein said entertainment module is an audio/video recorder module.

5. A modular, reconfigurable entertainment and data system according to claim 2 wherein said DVD module comprises:
a DVD player for playing a compact disc;
a processor coupled to said DVD player; and
a memory for storing the contents of the compact disc.

6. A modular, reconfigurable entertainment and data system according to claim 1 further comprising a first receiver module for positioning on a fourth one of said plurality of module receiving rails for receiving and processing TV data in a first format.

7. A modular, reconfigurable entertainment and data system according to claim 6 further comprising a second receiver module for positioning on a fifth one of said plurality of module receiving rails for receiving and processing TV data in a second format.

8. A modular, reconfigurable entertainment and data system according to claim 6 wherein said cabinet includes a backplane for providing electrical coupling between the modules.

9. A modular, reconfigurable entertainment and data system according to claim 8 wherein each of the modules is keyed so as to be received on only a specific one of said plurality of module receiving rails.

10. A modular, reconfigurable entertainment and data system according to claim 1 further comprising a data module for positioning on a fourth one of said plurality of module receiving rails.

11. A modular, reconfigurable entertainment and data system according to claim 10 wherein said data module includes a modem.

12. A modular, reconfigurable entertainment and data system for supplying data to at least one user, comprising:
a cabinet having a plurality of module receiving rails therein;
a power supply module for positioning on a first one of said plurality of module receiving rails for providing an operating potential;
a data module for positioning on a second one of said plurality of module receiving rails; and
a control module for positioning on a third one of said plurality of module receiving rails for providing an interface between the at least one user and said data module.

13. A modular, reconfigurable entertainment and data system according to claim 12 wherein said data module includes a modem.

14. A modular, reconfigurable entertainment and data system according to claim 12 further comprising a TV receiver module for positioning on a fourth one of said plurality of module receiving rails.

15. A modular, reconfigurable entertainment and data system according to claim 12 further comprising a DVD module for positioning on a fourth one of said plurality of module receiving rails.

16. A modular, reconfigurable entertainment and data system according to claim 12 further comprising a game module for positioning on a fourth one of said plurality of module receiving rails.

17. A modular, reconfigurable entertainment and data system for supplying data to at least one user, comprising:
a cabinet having a plurality of module receiving rails therein;
a power supply module for positioning on a first one of said plurality of module receiving rails for providing an operating potential;
a first TV receiver module for positioning on a second one of said plurality of module receiving rails for receiving and processing TV data in a first format;
a DVD module for positioning on a third one of said plurality of module receiving rails;
a data module for positioning on a fourth one of said plurality of module receiving rails;
a game module for positioning on a fifth one of said plurality of module receiving rails; and
a control module for positioning on a sixth one of said plurality of module receiving rails for providing an interface between said at least one user and said first TV receiver module, said DVD module, said data module, and said game module.

18. A modular, reconfigurable entertainment and data system according to claim 17 further comprising second TV receiver module for positioning on a seventh one of said plurality of module receiving rails for receiving and processing data in a second format.

19. A modular reconfigurable entertainment and data system for processing data received in a plurality of formats at an antenna and for supplying processed data to at least one user, comprising:
a cabinet having a plurality of module receiving rails therein;
a power supply module for positioning on a first one of said plurality of module receiving rails for providing an operating potential;
a first receiver module for positioning on a second one of said plurality of module receiving rails for receiving and processing data in a second one of said plurality of formats;
a second receiver module for positioning on a third one of said plurality of module receiving rails for receiving and processing data received in a second one of said plurality of formats; and
a control module for positioning on a fourth one of said plurality of module receiving rails and providing an interface between said at least one user and said first receiver module and said second receiver module.

20. A modular reconfigurable entertainment and data system according to claim 19 wherein said first one of said plurality of formats corresponds to a first geographic region.

21. A modular reconfigurable entertainment and data system according to claim 20 wherein said second one of said plurality of formats corresponds to a second geographic region.

22. A modular reconfigurable entertainment and data system according to claim 19 further comprising a third receiver module for positioning on a fifth one of said plurality of module receiving rails for receiving and processing data received in a third one of said plurality of formats.

23. A modular multi-regional TV system including a plurality of modules for processing TV data received in a plurality of formats at an antenna and for supplying processed TV data to at least one user display system, comprising:
a cabinet having a plurality of module receiving rails therein;
a power supply module for positioning on a first one of said plurality of module receiving rails for providing an operating potential;
an antenna control module for positioning on a second one of said plurality of module receiving rails for controlling the antenna;
a first receiver module for positioning on a third one of said plurality of module receiving rails for receiving and processing TV data received in a first one of said plurality of formats;
a second receiver module for positioning in a fourth one of said plurality of module receiving rails for receiving and processing TV data received in a second one of said plurality of formats; and
a control module for positioning on a fifth one of said plurality of module receiving slots and providing an interface between said at least one user display station, said first receiver module, and said second receiver module.

24. A multi-regional TV system according to claim 23 wherein said cabinet includes a backplane for providing electrical coupling between the modules.

25. A multi-regional TV system according to claim 23 wherein said multi-regional TV system is deployed on an aircraft which includes a navigation system coupled to said antenna control module.

26. A multi-regional TV system according to claim 23 wherein each of the modules is keyed so as to be received in only a specific one of said plurality of module receiving rails.

27. A multi-regional TV system according to claim 23 wherein the at least one user display station includes a switch for selecting one of said plurality of formats.

28. A multi-regional TV system according to claim 25 wherein said control module received geographic data from said inertial reference system to determine when the at least one user display station should be switched from said first one of said plurality of formats to said second one of said plurality of formats.

29. A multi-regional TV system according to claim 28 wherein said control module automatically switches the at least on user display station from said first one of said plurality of formats to said second one of said plurality of formats.

30. A multi-regional TV system according to claim 28 wherein said control module sends a message to the at least one user display station instructing a user to manually switch from said first one of said plurality of formats to said second one of said plurality of formats.

31. A multi-regional TV system according to claim 23 wherein said first one of said plurality of formats and said second one of said plurality of formats are the same.

32. A multi-regional TV system for use on an aircraft, the TV system for processing TV data received in a plurality of formats corresponding to a plurality of geographic regions, comprising:
an antenna for receiving the TV data;
a plurality of user display stations for viewing the TV data;
a navigation system for receiving and processing navigation information; and
a modular control unit electrically coupled to said antenna, said plurality of display stations, and said inertial reference systems, said modular control unit comprising:
a cabinet having a plurality of module receiving rails therein and having a backplane for providing communication paths in said cabinet;
a power supply module positioned on a first one of said plurality of module receiving rails for providing an operating potential;
an antenna control module electrically coupled to said antenna and to said navigation system and positioned on a second one of said plurality of module receiving rails for controlling said antenna;
a first receiver module positioned on a third one of said plurality of module receiving rails and coupled to said antenna for receiving and processing TV data received in a first one of said plurality of formats;
a second receiver module positioned on a fourth one of said plurality of module receiving rails and coupled to said antenna for receiving and processing TV data received in a second one of said plurality of formats; and
a switching module positioned on a fifth one of said plurality of module receiving rails for providing an interface between said modular control unit and said plurality of user display stations.

33. A multi-regional TV system according to claim 22 wherein each of said power supply module, said antenna control module, said first receiver module, and said second receiver module are each keyed so as to be received on only a corresponding specific one of said plurality of module receiving rails.

34. A multi-regional TV system according to claim 32 wherein said switching module receives geographic data from said navigation system to determine when said plurality of user display stations should be switched from said first one of said plurality of formats to said second one of said plurality of formats.

35. A multi-regional TV system according to claim 34 wherein each of said plurality of user display stations includes a switch for selecting one of said plurality of formats.

36. A multi-regional TV system according to claim 34 wherein said switching module automatically switches said plurality of user display stations from said first one of said plurality of formats to said second one of said plurality of formats.

37. A multi-regional TV system according to claim 34 wherein said switching module sends a message to said plurality of user display stations instructing users of said plurality of user display stations to manually switch from said first one of said plurality of formats to said second one of said plurality of formats.
